(19) United States
(12) Patent Application Publication
(10) Pub. No.: US 2015/0145807 A1
(43) Pub. Date: May 28, 2015

(54) TOUCH PANEL AND MANUFACTURING METHOD OF THE SAME

(71) Applicant: ETURBOTOUCH TECHNOLOGY INC., Zhongli City (TW)

(72) Inventors: KUEI-CHING WANG, LONGTAN TOWNSHIP (TW); TA-HU LIN, TAIPEI CITY (TW)

(73) Assignee: ETURBOTOUCH TECHNOLOGY INC., Zhongli City (TW)

(21) Appl. No.: 14/251,695

(22) Filed: Apr. 14, 2014

(30) Foreign Application Priority Data
Nov. 22, 2013 (TW) 102142567

(51) Int. Cl. G06F 3/041

(52) U.S. Cl. CPC G06F 3/041; G06F 2203/04102; G06F 2203/04103; G06F 2203/04111
USPC 345/174; 216/13

(57) ABSTRACT

A touch panel and a manufacturing method of the same are introduced, characterized in that an electrically conducting-connecting pad set electrically connects a second transmission line set and a second axial touch sensing set, such that a first transmission line set, the second transmission line set, and a first axial touch sensing set below the second axial touch sensing set are concurrently formed on a substrate of the touch panel in the same process flow of the manufacturing method to thereby dispense with a procedure of alignment of the first axial touch sensing set and the first transmission line set and a procedure of alignment of the second axial touch sensing set and the second transmission line set, so as to achieve high precision and enhance the production yield and efficiency of the touch panel.

### CROSS-REFERENCE TO RELATED APPLICATION

This non-provisional application claims priority under 35 U.S.C. §119(a) on Patent Application No(s). 102142567 filed in Taiwan, R.O.C. on Nov. 22, 2013, the entire contents of which are hereby incorporated by reference.

### FIELD OF TECHNOLOGY

The present invention relates to the technical field of touch panels, and more particularly, to a touch panel with a high process yield and a manufacturing method of the same.

### BACKGROUND

Conventional touch panel manufacturing technology has its disadvantages, namely touch panels (such as G/G, G/F/F, where G denotes glass, and F denotes thin film) manufactured by two-piece lamination are bulky and heavy to the detriment of portability. Hence, it is imperative to downsize touch panels.

The prior art of touch panel manufacturing is presently focused on reducing the stacking structure of touch panels, and thus the current solution thereof requires a one-piece touch panel structure, or known as One Glass/Finn Solution (OGS or OFS) with a view to reducing the stacking structure of the touch panels manufactured and thereby reducing the thickness and volume of the touch panels manufactured.

According to the prior art, a touch panel manufacturing process entails performing the steps of exposure, development, etching, and sputtering to manufacture a touch panel which comprises a plurality of conductive layers, a dielectric layer, and a metal layer. However, persons skilled in the art understand that not only a precision-related error which occurs in any of the above process steps will cause damage to a touch panel and thus reduce the process yield of touch panels, but the time taken to perform the manufacturing process and the cost of the manufacturing process also increase with the number of the aforesaid process steps.

Accordingly, it is imperative to enhance the process yield of touch panels and enhances the production efficiency thereof.

### SUMMARY

It is an objective of the present invention to enhance the precision of the alignment of components in a touch panel relative to each other.

Another objective of the present invention is to simplify the process flow of the manufacturing of touch panels and thus enhance the yield of the touch panels

In order to achieve the above and other objectives, the present invention provides a touch panel built-in with a first transmission line set, a first axial touch sensing set electrically connected to the first transmission line set, a second transmission line set, and a second axial touch sensing set electrically connected to the second transmission line set. The touch panel comprises: a substrate having a first area and a second area; a first conductive layer stacked on the substrate and disposed in the first area and the second area, wherein the first conductive layer disposed in the first area forms the first axial touch sensing set; an electrode layer stacked on the first conductive layer in the second area to form the first transmission line set and the second transmission line set together with part of the first conductive layer; an insulating layer stacked on the substrate in the first area and on the first axial touch sensing set; a second conductive layer stacked on the insulating layer to form the second axial touch sensing set in the first area; and an electrically conducting-connecting pad set stacked on part of the second transmission line set and part of the second conductive layer to electrically connect the second axial touch sensing set and the second transmission line set.

In order to achieve the above and other objectives, the present invention provides a touch panel manufacturing method, for producing a touch panel built-in with a first transmission line set, a first axial touch sensing set electrically connected to the first transmission line set, a second transmission line set, and a second axial touch sensing set electrically connected to the second transmission line set, the manufacturing method comprising the steps of: stacking a first conductive layer and an electrode layer successively in a first area and a second area of a substrate; performing a first patterning process to form the first axial touch sensing set in the first area and form the first transmission line set and the second transmission line set in the second area; stacking an insulating layer on the substrate in the first area and on the first axial touch sensing set; stacking a second conductive layer on the insulating layer; performing a second patterning process to form the second axial touch sensing set in the first area; and forming an electrically conducting-connecting pad set on part of the second axial touch sensing set and part of the second transmission line set so as for the second axial touch sensing set and the second transmission line set to be electrically connected to each other.

Accordingly, the present invention is characterized in that, due to a special technical feature of a touch panel of the present invention, that is, electrically connecting a second transmission line set and a second axial touch sensing set by an additional electrically conducting-connecting pad set, it is feasible that a first transmission line set, the second transmission line set, and a first axial touch sensing set below the second axial touch sensing set are formed on a substrate of the touch panel by the same process flow of a touch panel manufacturing method of the present invention, such that the alignment of the first axial touch sensing set and the first transmission line set and the alignment of the second axial touch sensing set and the second transmission line set are precise and thus dispense with an alignment procedure, so as to not only preclude alignment errors which might otherwise cause damage to the touch panel, but also simplify the manufacturing process of the touch panel and enhance the production yield and efficiency of the touch panel.

### BRIEF DESCRIPTION

Objectives, features, and advantages of the present invention are hereunder illustrated with specific embodiments in conjunction with the accompanying drawings, in which:

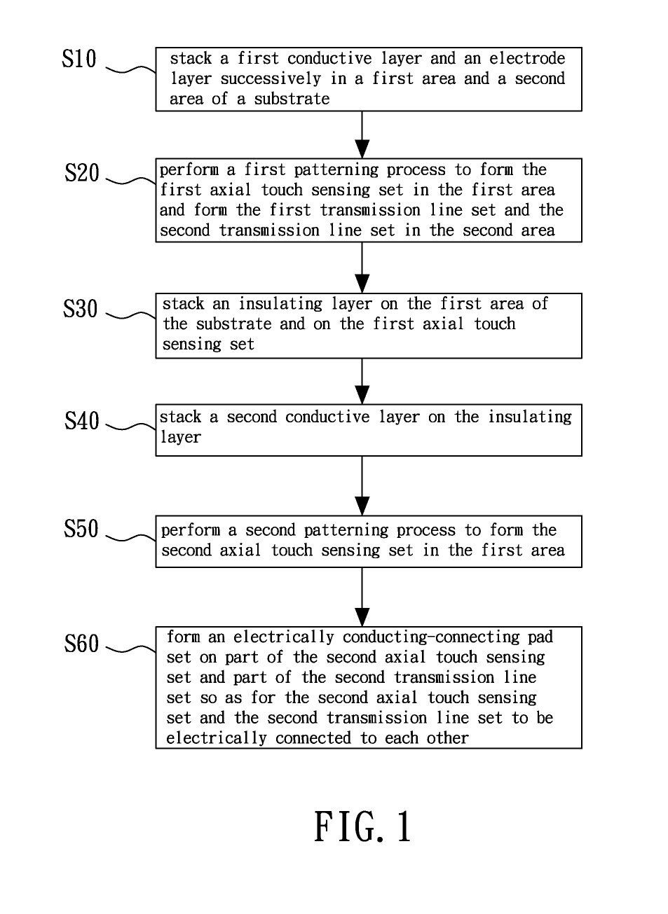

FIG. 1 is a flow chart of a method of manufacturing a touch panel according to an embodiment of the present invention;

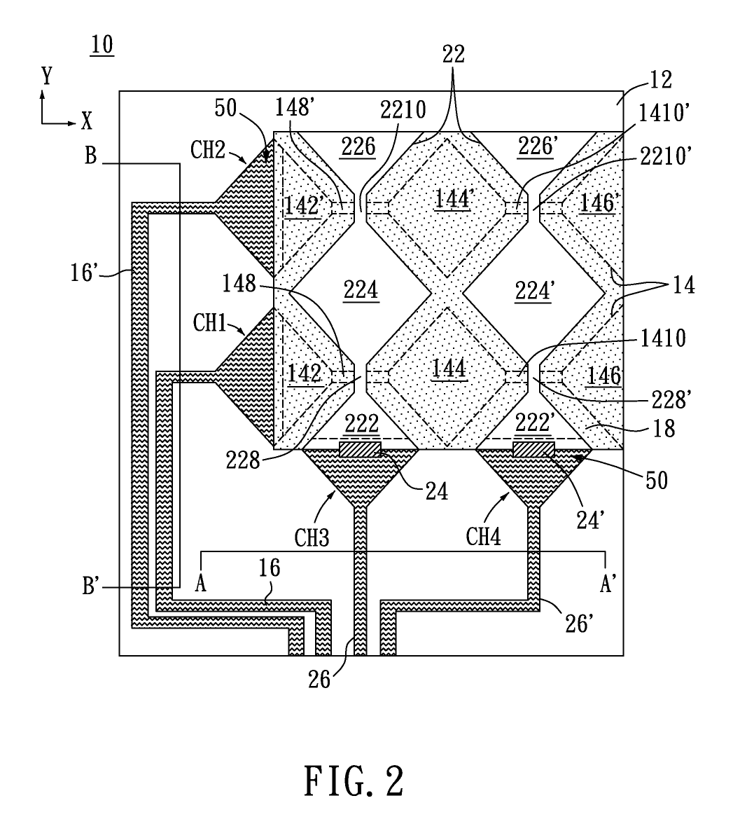

FIG. 2 is a top view of a touch panel according to an embodiment of the present invention;

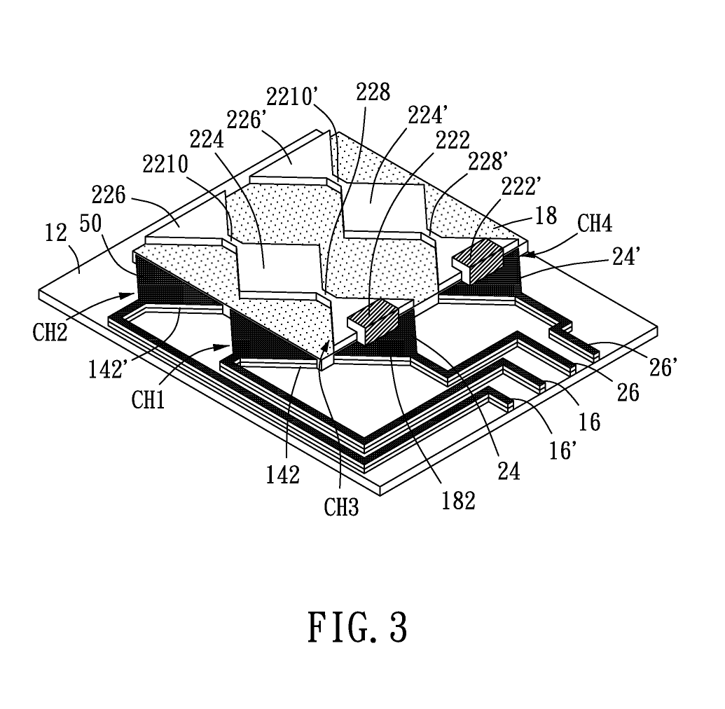

FIG. 3 is a perspective view of the touch panel shown in FIG. 2 according to an embodiment of the present invention; and

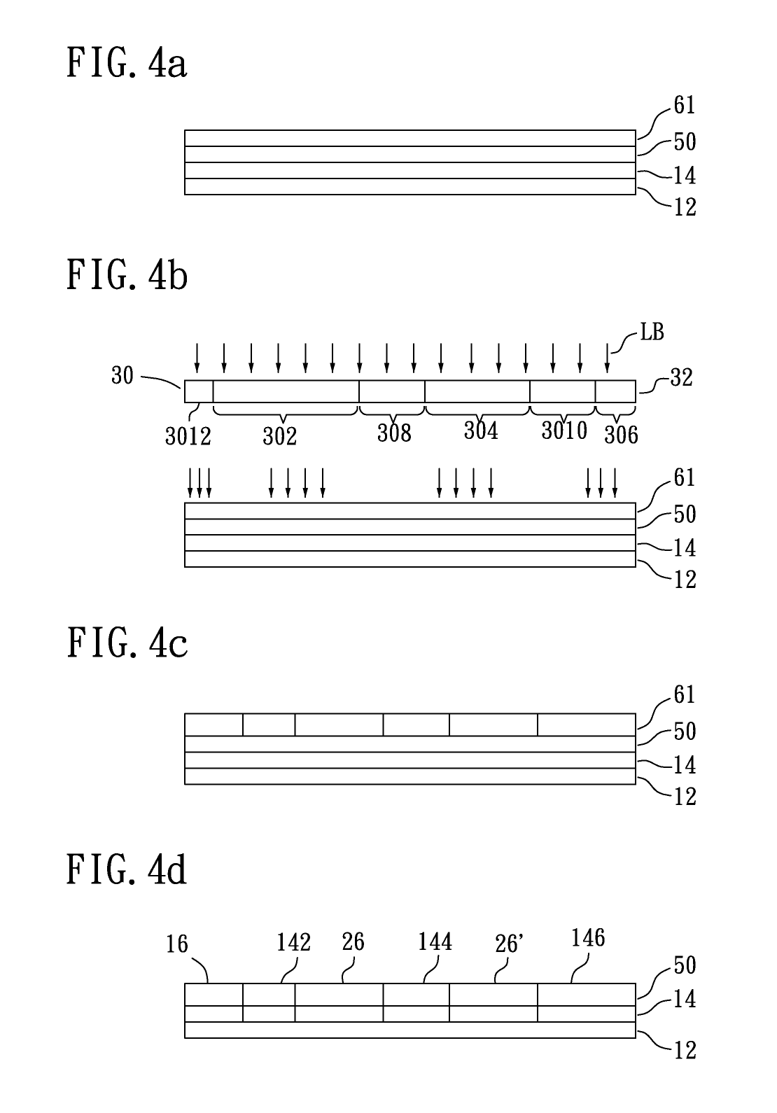

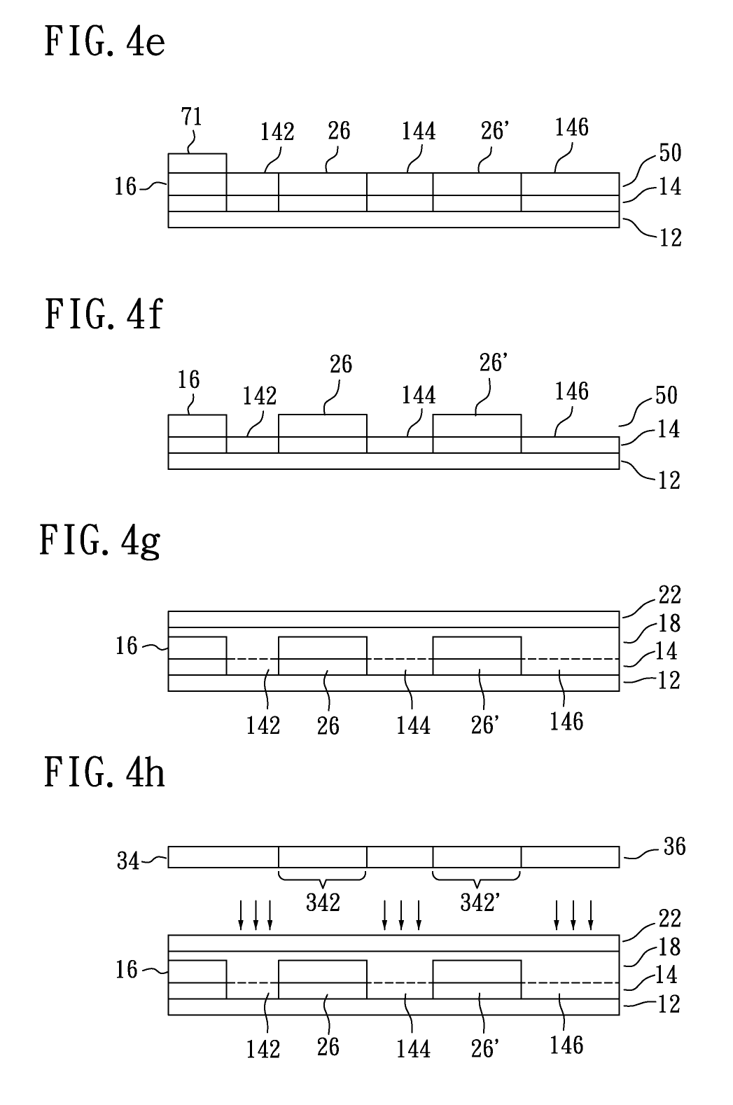

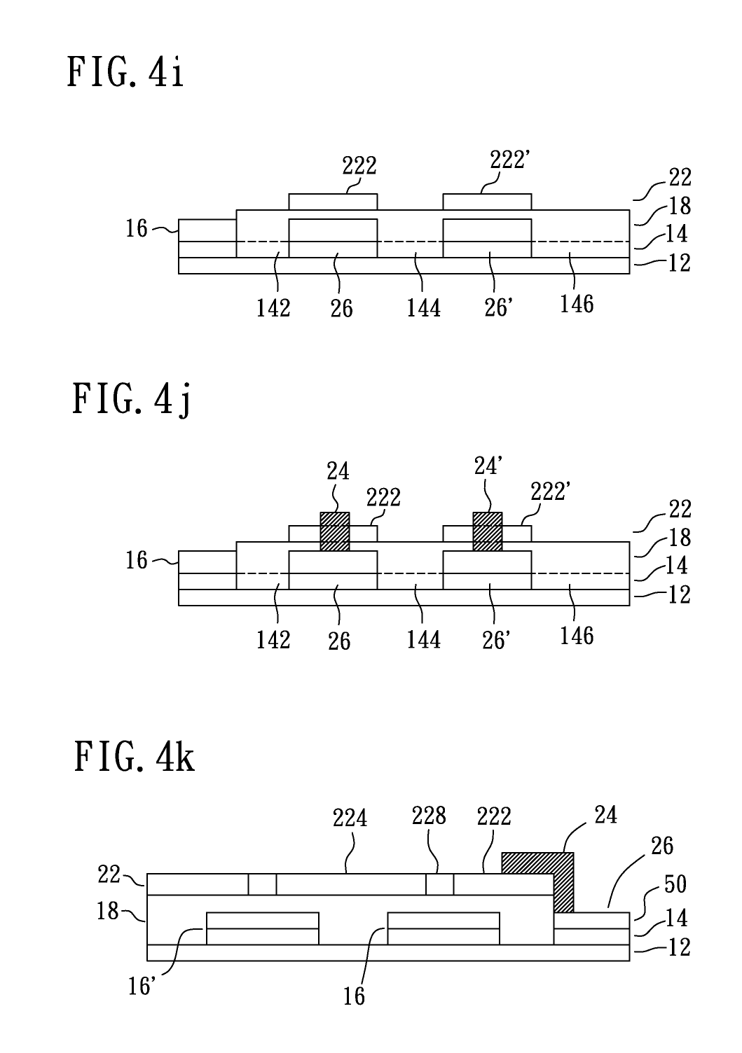

FIG. 4a through FIG. 4k are schematic views of the manufacturing process of the touch panel shown in FIG. 2 according to an embodiment of the present invention.

### DETAILED DESCRIPTION

Referring to FIG. 1, there is shown a flow chart of a method of manufacturing a touch panel according to an embodiment of the present invention. The present invention involves simplifying a manufacturing process and enhancing the accuracy of the positions of components relative to each other by means of an additional electrically conducting-connecting pad set. The present invention entails producing a touch panel conventionally built-in with a first transmission line set, a first axial touch sensing set electrically connected to the first transmission line set, a second transmission line set, and a second axial touch sensing set electrically connected to the second transmission line set. The touch panel manufacturing method comprises the steps described as follows:

Step S10: stacking a first conductive layer and an electrode layer successively in the first area and the second area of a substrate;

Step S20: performing a first patterning process to form the first axial touch sensing set in the first area and form the first transmission line set and the second transmission line set in the second area;

Step S30: stacking an insulating layer on the first area of the substrate and on the first axial touch sensing set;

Step S40: stacking a second conductive layer on the insulating layer;

Step S50: performing a second patterning process to form the second axial touch sensing set in the first area; and

Step S60: forming an electrically conducting-connecting pad set on part of the second axial touch sensing set and part of the second transmission line set so as for the second axial touch sensing set and the second transmission line set to be electrically connected to each other.

As indicated above, upon completion of the aforesaid process flow of the touch panel manufacturing method, the touch panel of the present invention comprises: a substrate, a first conductive layer, an electrode layer, an insulating layer, a second conductive layer and an electrically conducting-connecting pad set. The substrate has a first area and a second area. The first conductive layer is stacked on the substrate and disposed in the first area and the second area. The first conductive layer disposed in the first area forms the first axial touch sensing set. The electrode layer is stacked on the first conductive layer in the second area to form the first transmission line set and the second transmission line set together with part of the first conductive layer. The insulating layer is stacked on the substrate in the first area. The insulating layer is stacked on the first axial touch sensing set. The second conductive layer is stacked on the insulating layer to form the second axial touch sensing set in the first area. The electrically conducting-connecting pad set is stacked on part of the second transmission line set and part of the second conductive layer so as to be electrically connected to the second axial touch sensing set and the second transmission line set.

The aforesaid method and structure are hereunder illustrated with an embodiment and drawings.

Referring to FIG. 2, there is shown a top view of a touch panel according to an embodiment of the present invention. As shown in FIG. 2, the touch panel 10 comprises a substrate 12, a first conductive layer 14 (including two first sensing units 142, 142′, two third sensing units 144, 144′, two fifth sensing units 146, 146′, four first connecting units 148, 148′, 1410, 1410′, two first transmission lines 16, 16′ and two second transmission lines 26, 26′), an electrode layer 50, an insulating layer 18, a second conductive layer 22 (including two second sensing units 222, 222′, two fourth sensing units 224, 224′, two sixth sensing units 226, 226′, and four second connecting units 228, 228′, 2210, 2210′), and two electrically conducting-connecting pads 24, 24′. The first axial touch sensing set consists of the two first sensing units 142, 142′, two third sensing units 144, 144′, two fifth sensing units 146, 146′, and four first connecting units 148, 148′, 1410, 1410′. The first transmission line set consists of the two first transmission lines 16, 16′. The second transmission line set consists of the two second transmission lines 26, 26′. The electrically conducting-connecting pad set consists of the two electrically conducting-connecting pads 24, 24′.

The substrate 12 is selectively a flexible material. Alternatively, the substrate 12 is selectively an inflexible material. The substrate 12 can be made of whatever material which meets the requirements of the operation of the touch panel 10. For example, the substrate 12 is made of silicon dioxide, polyethylene, polypropylene, polyvinyl chloride, polycarbonate, polymethacrylate, polyethylene terephthalate, or any appropriate plastic material.

The first conductive layer 14 is stacked on the substrate 12. The first conductive layer 14 can be made of whatever material which meets the requirements of the operation of the touch panel 10. In this embodiment, the first conductive layer 14 is made of a transparent electrically conducting material, such as indium tin oxide, indium zinc oxide, cadmium tin oxide, aluminum zinc oxide, indium zinc tin oxide, zinc oxide, cadmium oxide, hafnium oxide, indium gallium zinc oxide, indium gallium zinc magnesium oxide, indium gallium oxide, indium gallium aluminum oxide, silver nanowire, grapheme, metal mesh, or any appropriate conductive material.

The first conductive layer 14 comprises a first channel CH1 and a second channel CH2. The first channel CH1 comprises the first sensing unit 142, the third sensing unit 144, the fifth sensing unit 146, two said first connecting units 148, 1410, and the first transmission line 16. The first connecting unit 148 is disposed between the first sensing unit 142 and the third sensing unit 144. The first connecting unit 1410 is disposed between the third sensing unit 142 and the fifth sensing unit 146. The first transmission line 16 is connected to the first sensing unit 142. The second channel CH2 comprises another first sensing unit 142, another third sensing unit 144, another fifth sensing unit 146, two other first connecting units 148, 1410, and the first transmission line 16.

The first channel CH1 has the same configuration as the second channel CH2 does. Hence, for the sake of brevity and illustration, the present invention is hereunder illustrated with the first channel CH1 rather than the first and second channels CH1, CH2.

As regards the first channel CH1, each of the three sensing units 142, 144, 146 is rhomboidal, and such a technical feature is illustrative rather than restrictive of the present invention. For example, in another embodiment, each of the three sensing units 142, 144, 146 is triangular, rectangular, or round. It is also feasible that the three sensing units 142, 144, 146 are in the number of one or two, or are provided in plurality. The drawings show the touch panel 10 in part.

As regards the first channel CH1, the first sensing unit 142, the third sensing unit 144, the fifth sensing unit 146 and two said first connecting units 148, 1410 are arranged in a first axial direction. In this embodiment, the first axial direction is the X axial direction, for the sake of illustration.

The substrate 12 has a first area and a second area. In this embodiment, the first area is defined as an active area on the touch panel 10, and the second area is defined as a border area on the touch panel 10. In this embodiment, rhomboidal portions of the first transmission line 16 and the first sensing unit 142 are disposed in the first area, whereas a remaining rhomboidal portion of the first sensing unit 142 is disposed in the second area.

The electrode layer 50 is stacked on the first transmission line 16 and on the first sensing unit 142 in the second area. In another embodiment, the electrode layer 50 is stacked on a portion of the first sensing unit 142 in the first area.

The insulating layer 18 is stacked on the first sensing unit 142 in the first area, on the third sensing unit 144, on the fifth sensing unit 146, and on the first connecting units 148, 1410.

The second conductive layer 22 is stacked on the insulating layer 18. The second conductive layer 22 is made of the same material as the first conductive layer 14 is.

The second conductive layer 22 comprises a third channel CH3 and a fourth channel CH4. The third channel CH3 comprises the second sensing unit 222, the fourth sensing unit 224, the sixth sensing unit 226, two said second connecting units 228, 2210 and the second transmission line 26. The second connecting unit 228 is disposed between the second sensing unit 222 and the fourth sensing unit 224. The second connecting unit 2210 is disposed between the fourth sensing unit 224 and the sixth sensing unit 226. The second transmission line 26 is connected to the second sensing unit 222. The fourth channel CH4 comprises another second sensing unit 222, another fourth sensing unit 224, another sixth sensing unit 226, and two other said second connecting units 228, 2210.

The third channel CH3 has the same configuration as the fourth channel CH4 does. Hence, for the sake of brevity and illustration, the present invention is hereunder illustrated with the third channel CH3 rather than the third and fourth channels CH3, CH4.

As regards the third channel CH3, each of the three said sensing units 222, 224, 226 is rhomboidal, and such a technical feature is illustrative rather than restrictive of the present invention. For example, in another embodiment, each of the three said sensing units 222, 224, 226 is triangular, rectangular, or round. In this embodiment, for the sake of illustration, the sensing units are in the number of three. The drawings illustrate the touch panel 10 in part.

The second sensing unit 222, the fourth sensing unit 224, the sixth sensing unit 226, and two said second connecting units 228, 2210 are arranged in a second axial direction. In this embodiment, the second axial direction is the Y axial direction, for the sake of illustration.

In this embodiment, rhomboidal portions of the second transmission line 26 and the second sensing unit 222 are disposed in the first area (the active area), whereas a remaining rhomboidal portion of the second sensing unit 222 is disposed in the second area (the border area). The electrode layer 50 is stacked on the second transmission line 26 in the second area. In another embodiment, the electrode layer 50 is stacked on a portion of the second sensing unit 222 in the first area.

The second sensing unit 222 has a rhomboidal lower half portion. The electrically conducting-connecting pad 24 is stacked on at least a portion of the rhomboidal lower half portion of the second sensing unit 222 and on the second transmission line 26 to electrically connect the second sensing unit 222 and the second transmission line 26 and thereby form the third channel CH3. As a result, the electrically conducting-connecting pad set is stacked on part of the second transmission line set and part of the second conductive layer, as mentioned above. In another embodiment, a portion of the second transmission lines 26, 26′ is not connected to the electrically conducting-connecting pad set, wherein the insulating layer 18 is stacked on the portion of the second transmission lines 26, 26′ and stacked on the first transmission lines 16, 16′.

Referring to FIG. 3, there is shown a perspective view of the touch panel 10 shown in FIG. 2 according to an embodiment of the present invention.

Referring to FIGS. 3a-3k, there are shown schematic views of the manufacturing process of the touch panel 10 shown in FIG. 2 according to an embodiment of the present invention. Referring to FIGS. 4a-4j, there are shown cross-sectional views of the touch panel 10 taken along line A-A′ of FIG. 2. Referring to FIG. 4k, there is shown a cross-sectional view of the touch panel 10 taken along line B-B′ of FIG. 2.

Referring to FIG. 4a, there is shown the step of stacking a first conductive layer 14, an electrode layer 50 and a first photoresist layer 61 successively on a substrate 12. In this embodiment, the first conductive layer 14 is made of indium tin oxide, the electrode layer 50 of metal, such as copper, and the first photoresist layer 61 of a negative photoresist material, for the sake of illustration. The negative photoresist material is characterized in that: in the situation where the negative photoresist material is irradiated with ultraviolet (UV), the non-irradiated portion of the negative photoresist material can be removed by a developer. The first photoresist layer 61 is formed by means of coating, adhesion, printing, or lamination.

Referring to FIG. 4b, there is shown the step of performing exposure on the first photoresist layer 61 by a first mask 32 having a first pattern group 30. In the cross-sectional view taken along line A-A′, the first mask 32 reveals a first sensing pattern 302, a third sensing pattern 304, a fifth sensing pattern 306, two first connecting patterns 308, 3010, a first connection line pattern 3012 and a second connection line pattern 3014 (not shown). The patterns 302, 304, 306, 308, 3010, 3012, 3014 are arranged in the first axial direction. A light beam LB falls on the first mask 32 (to perform an exposure process), such that the first photoresist layer 61 forms the first pattern group 30.

Referring to FIG. 4c, there is shown the step of performing a development process on the first photoresist layer 61 to remove, with a developer, the photoresist not irradiated with the light beam LB.

Referring to FIG. 4d, there is shown the step of performing etching and photoresist-removing process on the electrode layer 50 and the first conductive layer 14 to form a first sensing unit 142, a third sensing unit 144, a fifth sensing unit 146, two first connecting units 148, 1410 (not shown), a first transmission line 16 and two second transmission lines 26, 26′ on the first conductive layer 14 and the electrode layer 50. In this embodiment, the first transmission line 16 and the second transmission lines 26, 26′ are disposed in the second area of the substrate 12.

Referring to FIG. 4e, there is shown the step of stacking a first etching resist layer 71 on the second transmission lines 26, 26′ and the first transmission line 16 in the second area. In this embodiment, the first etching resist layer is made of etching-resistant ink for the sake of illustration.

Referring to FIG. 4f, there is shown the step of performing etching and ink-removing on the electrode layer 50 to reveal the first sensing unit 142, the third sensing unit 144, the fifth sensing unit 146 and the first connecting units 148, 1410 (not shown) on the first conductive layer 14 in the first area.

Referring to FIG. 4g, there is shown the step of stacking an insulating layer 18 on the substrate 12, the electrode layer 50 and the first conductive layer 14 and then stacking a second conductive layer 22 on the insulating layer 18. In an aspect of embodiment of the present invention, the second conductive layer 22 is made of a photosensitive electrically conducting film to facilitate the direct exposure and development which take place subsequently.

Referring to FIG. 4h, there is shown the step of performing exposure on the second conductive layer 22 by a second mask 36 having a second pattern group 34, so as to form the second pattern group 34 on the second conductive layer 22, wherein the second pattern group 34 comprises two second sensing patterns 342, 342′ and two second connecting patterns 344, 344′ (not shown).

Referring to FIG. 4i, there is shown the step of performing a development process on the second conductive layer 22 and the insulating layer 18, so as to form the second sensing units 222, 222′ and the second connecting units 228, 228′ (not shown) on the second conductive layer 22.

Referring to FIG. 4j, there is shown the step of connecting the electrically conducting-connecting pads 24, 24′ between the second sensing unit 222 and the second transmission line 26 and between the second sensing unit 222 and the second transmission line 26, respectively, so as to form the third channel CH3 and the fourth channel CH4, respectively.

In conclusion, from the perspective of process steps, a touch panel manufacturing method according to an embodiment of the present invention comprises the steps as follows:

Step S10: stacking a first conductive layer and an electrode layer successively in a first area and a second area of a substrate.

Step S20: performing a first patterning process with the sub-steps of:

stacking a first photoresist layer on the electrode layer;

performing exposure and development on the first photoresist layer by a first mask having a first pattern group, so as for the first photoresist layer to form a pattern group, including the first axial touch sensing set, the first transmission line set and the second transmission line set (that is, forming a pattern group including a first sensing unit, a third sensing unit, a first connecting unit, a first transmission line and a second transmission line;

performing etching to etch the electrode layer and the first conductive layer by means of the pattern groups and thus form the first transmission line set and the second transmission line set (that is, performing integral etching and then finalizing the first axial touch sensing set);

stacking an etching resist layer on the electrode layer and the substrate in the second area; and

performing etching to remove the electrode layer from the first area and thereby reveal the third sensing unit, the first connecting unit, and the first sensing unit of the first conductive layer in the first area and form the first axial touch sensing set.

Step S30: stacking an insulating layer on the substrate in the first area and on the first axial touch sensing set.

Step S40: stacking a second conductive layer on the insulating layer.

Step S50: performing a second patterning process. Step S50 entails performing exposure and development on the second conductive layer by a second mask having a pattern group of the second axial touch sensing set, so as to form the second conductive layer on the second axial touch sensing set in the first area, that is, forming a second sensing unit, a fourth sensing unit, and a second connecting unit, wherein the second sensing unit, the fourth sensing unit, and the second connecting unit are arranged in a second axial direction.

Step S60: forming an electrically conducting-connecting pad set on part of the second axial touch sensing set and part of the second transmission line set to electrically connect the second axial touch sensing set and the second transmission line set.

In conclusion, the present invention is characterized in that, due to a special design of a touch panel of the present invention, a first transmission line set, a second transmission line set, and a first axial touch sensing set below the second axial touch sensing set are formed on a substrate of the touch panel by the same process flow of a touch panel manufacturing method of the present invention, such that the position of the first axial touch sensing set relative to the second axial touch sensing set and the position of the first transmission line set relative to the second transmission line set are precise enough to dispense with an alignment procedure, so as to not only preclude alignment errors which might otherwise cause damage to the touch panel, but also attain high precision and enhance the production yield and efficiency of the touch panel.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A touch panel, built-in with a first transmission line set, a first axial touch sensing set electrically connected to the first transmission line set, a second transmission line set, and a second axial touch sensing set electrically connected to the second transmission line set, the touch panel comprising:
a substrate having a first area and a second area;
a first conductive layer stacked on the substrate and disposed in the first area and the second area, wherein the first conductive layer disposed in the first area forms the first axial touch sensing set;
an electrode layer stacked on the first conductive layer in the second area to form the first transmission line set and the second transmission line set together with part of the first conductive layer;
an insulating layer stacked on the substrate in the first area and on the first axial touch sensing set;
a second conductive layer stacked on the insulating layer to form the e second axial touch sensing set in the first area; and
an electrically conducting-connecting pad set stacked on part of the second transmission line set and part of the second conductive layer to electrically connect the second axial touch sensing set and the second transmission line set.

2. The touch panel of claim 1, wherein sensing units in the first axial touch sensing set and the second axial touch sensing set are rhomboidal, triangular, rectangular, or round.

3. The touch panel of claim 1, wherein the electrode layer is made of metal.

4. The touch panel of claim 1, wherein the first conductive layer and the second conductive layer are made of an electrically conducting material comprising one selected from the group consisting of indium tin oxide, indium zinc oxide, cadmium tin oxide, aluminum zinc oxide, indium zinc tin oxide, zinc oxide, cadmium oxide, hafnium oxide, indium gallium zinc oxide, indium gallium zinc magnesium oxide, indium gallium oxide, indium gallium aluminum oxide, silver nanowire, graphene, metal mesh, and any appropriate conductive material.

5. The touch panel of claim 1, wherein the substrate is made of one selected from the group consisting of silicon dioxide, polyethylene, polypropylene, polyvinyl chloride, polycarbonate, polymethacrylate, polyethylene terephthalate, and any appropriate plastic material.

6. The touch panel of claim 1, wherein the substrate is made of a flexible material.

7. The touch panel of claim 1, wherein the insulating layer is transparent.

8. A touch panel manufacturing method, for producing a touch panel having a first transmission line set, a first axial touch sensing set electrically connected to the first transmission line set, a second transmission line set, and a second axial touch sensing set electrically connected to the second transmission line set, the manufacturing method comprising the steps of:
stacking a first conductive layer and an electrode layer successively in a first area and a second area of a substrate;
performing a first patterning process to form the first axial touch sensing set in the first area and form the first transmission line set and the second transmission line set in the second area;
stacking an insulating layer on the substrate in the first area and on the first axial touch sensing set;
stacking a second conductive layer on the insulating layer;
performing a second patterning process to form the second axial touch sensing set in the first area; and
forming an electrically conducting-connecting pad set on part of the second axial touch sensing set and part of the second transmission line set so as for the second axial touch sensing set and the second transmission line set to be electrically connected to each other.

9. The manufacturing method of claim 8, wherein the first patterning process comprises the sub-steps of:
stacking a first photoresist layer on the electrode layer;
performing exposure and development on the first photoresist layer by a first mask having a first pattern group so as for the first photoresist layer to form a pattern group of the first axial touch sensing set, the first transmission line set and the second transmission line set;
performing etching to etch the electrode layer and the first conductive layer by means of the pattern groups and thus form the first transmission line set and the second transmission line set;
stacking an etching resist layer on the electrode layer and the substrate in the second area; and
performing etching to remove the electrode layer from the first area and thereby form the first axial touch sensing set.

10. The manufacturing method of claim 9, wherein the etching resist layer is an etching-resistant ink layer.

11. The manufacturing method of claim 8, wherein the second patterning process comprises the sub-step of performing exposure and development on the second conductive layer by a second mask having a pattern group of the second axial touch sensing set, so as to form the second axial touch sensing set on the second conductive layer in the first area.

12. The manufacturing method of claim 11, wherein the second conductive layer is a photosensitive electrically conducting film layer.
